(19) United States
(12) Patent Application Publication
(10) Pub. No.: US 2026/0296351 A1
(43) Pub. Date: Oct. 1, 2026

(54) RESTRAINT SYSTEM, VEHICLE SEAT, AND CORRESPONDING METHOD

(71) Applicant: Autoliv Development AB, Vargarda (SE)

(72) Inventor: Günter CLUTE, Elmshorn (DE)

(21) Appl. No.: 19/478,537

(22) PCT Filed: Apr. 19, 2024
(86) PCT No.: PCT/EP2024/060752

§ 371 Date: Oct. 24, 2025

(30) Foreign Application Priority Data
Apr. 25, 2023 (DE) 10 2023 110 547.7

(51) Int. Cl. B60R 21/015; B60N 2/64; B60R 21/01; B60R 21/207; B60R 21/231; B60R 22/26; B60R 22/34; G01S 13/08

(52) U.S. Cl. CPC B60R 21/0153; B60N 2/64; B60R 21/207; B60R 21/231; B60R 22/26; B60R 22/34; G01S 13/08; B60R 2021/01034; B60R 2021/01231; B60R 2021/01238; B60R 2021/23153; B60R 2022/266

(57) ABSTRACT

A restraint system for installation in a backrest of a motor vehicle, wherein the restraint system has an airbag, wherein the airbag is configured to restrain an occupant behind the backrest. The restraint system has a radar sensor which is configured to detect an occupant behind the backrest. The invention further relates to a corresponding vehicle seat and to a corresponding control method.

The present invention relates to a restraint system for installation in a backrest of a motor vehicle, to a corresponding backrest and to a corresponding method for controlling the restraint system.

Due to their design, restraint systems for occupants in the rear seats of a motor vehicle are subject to different requirements than those for driver and front passenger restraint systems. Due to the possible positions for occupants in the rear seat and the generally variable distance between the front seats and the rear seats as a result of the adjustability of the front seats in the vehicle's longitudinal direction, very different conditions arise which make it difficult to effectively restrain an occupant in a rear seat.

It is therefore the object of the present invention to provide a restraint system for an occupant in a rear vehicle seat of a motor vehicle, which enables adaptation to the relevant conditions in the vehicle and the position of the occupant. Furthermore, the object of the invention is to provide a corresponding vehicle seat comprising a restraint system and a corresponding control method.

To address the object, a restraint system for installation in a backrest of a motor vehicle is proposed. The restraint system comprises an airbag, the airbag being configured to restrain an occupant behind the backrest. It is proposed that the restraint system comprises a radar sensor which is configured to detect an occupant behind the backrest.

The arrangement of the radar sensor and the airbag in a restraint system enables the occupant to be detected directly in front of the airbag, thus enabling effective detection of the situation and conditions in front of the airbag of the restraint system. The airbag for the occupant of a vehicle seat behind the restraint system or behind a vehicle seat comprising such a restraint system can thus be adaptively deployed in accordance with the conditions. For example, different seating positions of the front vehicle seats can be compensated for in this way. Preferably, an electronic control unit is provided which is configured to control the radar sensor and the airbag using open-loop and/or closed-loop control.

In an advantageous embodiment, the radar sensor is arranged next to the airbag. In this way, the distance measured can be particularly effectively correlated with the real conditions in front of the airbag, for example the distance between the occupant and the airbag before it is deployed. This allows for very advantageous adaptive deployment behavior of the airbag.

According to an advantageous development, it is proposed that the airbag and the radar sensor are fastened to a belt retractor. For example, the airbag, the radar sensor and the belt retractor can be provided in one module or assembly. This allows them to be mounted in or on the backrest of a vehicle seat in a simple manner. The airbag and radar sensor are preferably fastened to the housing of a belt retractor. Furthermore, the airbag and the radar sensor are preferably arranged below the winding axis of a belt retractor when installed.

In an advantageous embodiment, the belt retractor, in particular a housing of the belt retractor, forms a cross member for a rear seat. Such a belt retractor can, for example, structurally connect two vertical structural elements of a backrest in the upper region of a backrest so that the belt retractor becomes part of the seat structure itself. This allows for a weight reduction and simplifies the structural integration of the airbag, especially when the airbag and radar sensor are fastened to the belt retractor.

It is further proposed that the restraint system has an electronic control unit which is designed to control the airbag, the radar sensor and the belt retractor. Therefore, a control unit can be used to actuate the belt retractor for a passenger in a front seat, which belt retractor uses the backrest in which the restraint system can be installed, and the radar sensor and the airbag for a passenger in a rear vehicle seat can be actuated by the same control device. This allows the number of control devices and the necessary electrical and data connections to be reduced.

Preferably, the radar sensor is configured to measure a distance from an occupant. This enables particularly adaptive control of the restraint system so that the airbag can be deployed on the basis of on the measured distance.

Furthermore, the airbag can preferably be controlled on the basis of the data recorded by the radar sensor. This thus allows for adaptive control of the airbag, which is adapted to the relevant conditions.

Furthermore, to achieve the object of the invention, a vehicle seat for a motor vehicle is proposed, which comprises a backrest, wherein the backrest has a restraint system according to any one of claims 1 to 7.

The previously described advantages and features of the restraint system also apply to the vehicle seat comprising such a restraint system. Therefore, an occupant in a vehicle seat behind the vehicle seat comprising the restraint system can be protected by the restraint system's airbag, wherein the airbag can be adaptively controlled as a result of the radar sensor.

Furthermore, in order to achieve the object of the invention, a method for controlling a restraint system according to any one of claims 1 to 7 is proposed. It is proposed that the ignition time of the airbag and/or the inflation behavior of the airbag over time and/or the inflation behavior of the airbag in terms of its geometry is controlled on the basis of the radar sensor. This allows an occupant to be advantageously restrained with reduced loading by means of the adaptive control of the airbag. The loading can be reduced, for example, by adjusting the ignition time and/or the pressure and/or size of the airbag.

It is further proposed that the radar sensor detects the distance from and/or size of an occupant. The distance from an occupant refers to an occupant behind the restraint system who can be restrained by the airbag when inflated. Detecting the size of an occupant allows for further improvement of the adaptive deployment of the airbag.

The invention is explained below using preferred embodiments with reference to the accompanying figures. In the figures:

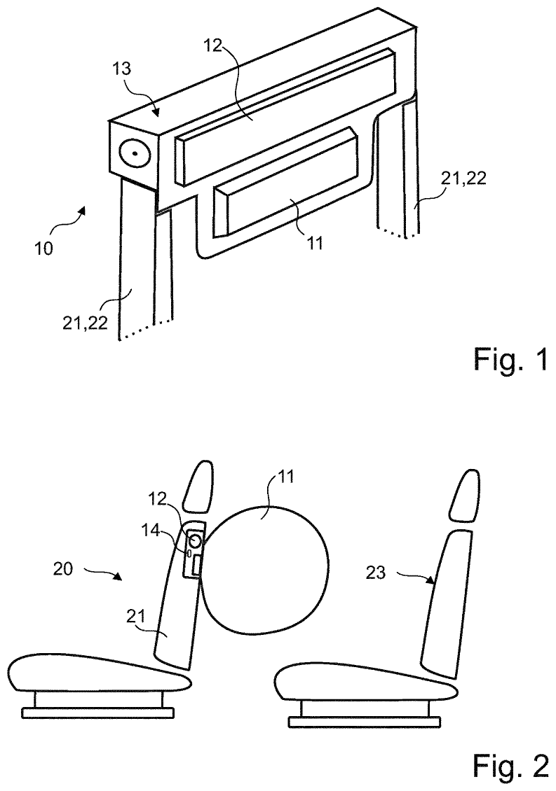

FIG. 1 shows a restraint system comprising an airbag, radar sensor and belt retractor on two vertical structural elements of a vehicle seat; and

FIG. 2 shows a vehicle seat comprising a restraint system in the backrest, with an inflated airbag in front of a rear vehicle seat.

FIG. 1 schematically shows an advantageous embodiment of a restraint system 10 for a motor vehicle. The restraint system 10 is intended for installation in a backrest 21 of a vehicle seat 20, wherein the two vertical structural elements 22 of a backrest 21 are shown, onto which the restraint system 10 is placed in this advantageous embodiment.

The restraint system 10 comprising an airbag 11 which faces rearward toward a rear occupant. In addition to the airbag 11, a radar sensor 12 is provided, which also faces rearward toward an occupant behind the restraint system 10 in the direction of travel.

In this advantageous embodiment, the radar sensor 12 and the airbag 11 are mounted on a belt retractor 13, which forms a structural connection between the vertical structural elements 22 of the backrest 21. The restraint system 10 can be mounted in a module together with the belt retractor 13 on the vehicle seat 21, in particular the backrest 21 of the vehicle seat 20.

In this advantageous embodiment, the restraint system 10 and the belt retractor 13 have a common electronic control unit 14 (see also FIG. 2), which controls the functions of the restraint system 10 as well as the belt retractor 13. Furthermore, in this embodiment, the belt retractor 13 and the restraint system 10 can be connected to the same electrical connection.

In alternative embodiments, the restraint system can also be mounted on a backrest 21 independently of a belt retractor 13. Furthermore, the restraint system 10 can also have an electronic control unit 14 which only controls the functions of the restraint system 10.

FIG. 2 is a schematic side view of the restraint system 10 in a vehicle seat 20. The restraint system 10 in the backrest 21 of the vehicle seat 20 faces toward the rear seat 23 together with the airbag 11 and the radar sensor 12. In the illustration in FIG. 2, the airbag 11 is shown in the deployed state.

The restraint system 10 according to FIGS. 1 and 2 detects the distance from an occupant during operation using the radar sensor 12. Furthermore, the distance measurement can also be used to determine, for example, whether a passenger is actually sitting in the rear seat 23. Accordingly, the deployment behavior of the airbag 11 can be adaptively adjusted in the event of a crash. For example, the time of deployment, the depth of the airbag and the inflation behavior of the airbag 11 can be adaptively controlled on the basis of the radar data detected by the radar sensor 12.

Furthermore, in one possible embodiment, a belt retractor for an occupant in the rear seat 23 can also be controlled in terms of its load limiting curves by the data recorded by the radar sensor 12, for example the distance from the radar sensor 12 to an occupant.

1. A restraint system for installation in a backrest of a motor vehicle, the restraint system having an airbag, the airbag being designed to restrain an occupant behind the backrest, wherein the restraint system has a radar sensor which is designed to detect an occupant behind the backrest.

2. The restraint system according to claim 1, characterized wherein the radar sensor is arranged next to the airbag.

3. The restraint system according to claim 1, wherein the airbag and the radar sensor are fastened to a belt retractor.

4. The restraint system, according to claim 3, wherein the belt retractor forms a cross member for a rear seat.

5. The restraint system according to claim 1, wherein the restraint system has an electronic control unit which is designed to control the airbag, the radar sensor and the belt retractor.

6. The restraint system according to claim 1, wherein the radar sensor is designed to measure a distance to an occupant.

7. The restraint system according to claim 1, wherein the airbag can be controlled on the basis of the recorded data of the radar sensor.

8. A vehicle seat for a motor vehicle, comprising a backrest wherein the backrest has the restraint system according to claim 1.

9. A method for controlling the restraint system according to claim 1, wherein the ignition time of the airbag and/or the inflation behavior of the airbag is controlled over time and/or the inflation behavior of the airbag in the geometry is controlled on the basis of the radar sensor.

10. The method for controlling a restraint system according to claim 9, wherein the radar sensor detects the distance and/or the size of an occupant.
